(19) United States
(12) Patent Application Publication
(10) Pub. No.: US 2003/0130414 A1
(43) Pub. Date: Jul. 10, 2003

(54) Alpha-methylene lactone homopolymer and copolymer compositions, sheets and articles made therefrom and the process for their manufacture

(76) Inventors: Charles Brandenburg, Wilmington, DE (US); Elizabeth P. Butler, Wilmington, DE (US); Carl Erkenbrecher, Elkton, MD (US); Randy King, Kennett Square, PA (US); Clyde Hutchins, Boston, NY (US); Rutger D. Puts, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/032,978

(22) Filed: Dec. 28, 2001

Related U.S. Application Data
(60) Provisional application No. 60/259,191, filed on Dec. 29, 2000.

(51) Int. Cl. C08L 1/00

(52) U.S. Cl. 524/592

(57) ABSTRACT

Compositions comprising homopolymers or copolymers containing repeat units derived from α-methylenelact(ones)(ams) such as α-methylenebutyrolactones and an inorganic filler such as alumina trihydrate are described. The decorative sheets and articles made from these compositions may have one or more of higher thermal resistance, higher hardness, higher scratch and mar resistance, faster polymerization rates, antimicrobial properties, lower coefficient of thermal expansion and, owing to a higher refractive index, a higher transparency.

### FIELD OF INVENTION

Filled polymer compositions, and more particularly, aesthetically pleasing polymeric articles such as decorative surface materials made from homo- or copolymers of an α-methylene lact(one)(am) and an alkyl acrylate monomer, filled with an alumina trihydrate filler are described.

### TECHNICAL BACKGROUND

Filled plastics, and various methods for their manufacture constitute a well developed art. Especially, articles formed from these filled plastics via injection molding and subsequent cross-linking of the polymeric matrix comprise a large body of commercially useful products. Often, articles of manufacture are comprised of a thermoplastic or thermosetting polymeric matrix and an inert filler, such as calcium carbonate, calcium sulfate, calcium silicate, silica, clay, calcined alumina, alumina trihydrate, spheres, talc, kaolin, feldspar, baryte, mica, calcium sulfate, hollow glass spheres, ceramic materials, carbon black or carbon fiber. Other filler materials include nylon flock fibers, and polyester fibers. Articles of manufacture comprising polymeric methyl methacrylate homopolymer and an alumina trihydrate filler are disclosed in U.S. Pat. No. 3,084,068, Re.27,093, U.S. Pat. Nos. 3,847,865 and 4,107,135.

Among the uses of these filled plastics are decorative solid surfacing materials such as simulated marble, kitchen sinks, bathroom sinks, table tops, counter tops, dresser tops, vanity tops, shelving, and furniture applications. Depending on the severity of these applications, properties such as toughness, temperature resistance, scratch resistance, microbial resistance, translucency, and flame resistance of the laminate surface are very important. Most of these decorative surface materials are manufactured with poly (methyl methacrylate) (hereinafter referred to as PMMA) as a matrix material with different inert fillers.

PMMA offers excellent optical clarity (92% of white light) and brilliance. It remains unaffected by most household detergents, cleaning agents and solutions of inorganic acids, and alkalis. Moreover, it is amenable to forming shapes via injection molding, extrusion, and polymerization casting.

Like most other thermoplastics, PMMA exhibits a higher coefficient of thermal expansion as compared to metals. However, the most significant disadvantage of PMMA is that its thermal properties limit its use in articles. PMMA softens circa. 115° C. and its continuous service temperature is lower, approximately 95° C. Therefore, other plastic materials are used in high temperature applications. In the specific usage of decorative sheets and related articles, three limitations are observed in high performance applications: (i) ineffective ability to withstand higher temperature conditions (in the range of 100° C. through 200° C.), (ii) lower material hardness of materials with a PMMA matrix and (iii) lower scratch and mar resistance of such materials. Thus, polymeric matrix materials with good temperature resistance and/or scratch resistance and/or higher flexural modulus are desired.

In the manufacture of such filled plastic articles such as decorative surfaces, monomer volatility can be an environmental hazard issue. A lower volatility monomer is usually desired.

Since the refractive index of the fillers is usually high, a closer match of the refractive index of the polymer to the matrix, while preserving other properties such as clarity and weatherability is desired to create materials with a greater translucency.

Copolymers of an alpha-methylene gamma-butyrolactone (hereinafter referred to as α-MBL) with various vinyl monomers are known in the literature (Kunstoffe, 87, pp 734-736, 1997; incorporated herein by reference). Making copolymers from methyl methacrylate or other monomers and an exomethylene lact(one)(am) monomer is described in U.S. Pat. No. 5,880,325.

British patent 614,310 and U.S. Pat. No. 2,624,723 describe the synthesis of methylene lactone homopolymers. The British patent also mentions the possibility of additives such as fillers and coloring materials to modify the homopolymer properties. U.S. Pat. No. 3,847,865, U.S. Re. 27,903 and U.S. Pat. No. 4,107,135 describe a process where a decorative surface can be formed using PMMA as the matrix or its copolymers as the matrix, for example, ethylenically unsaturated compounds as co-monomers. These patents teach how to fabricate decorative sheet with a polymer matrix and a filler such as calcium carbonate, alumina trihydrate, nylon fiberstock, polyester fiber, silica, spheres, talc, kaolin, feldspar, baryte, mica, calcium sulfate, hollow glass spheres, ceramic materials, carbon black or carbon fiber.

### SUMMARY OF INVENTION

This invention concerns a composition comprising, a copolymer of at least one α-methylene lact(one)(am) monomer of formula (I) and at least one other free radically copolymerizable monomer, and an inorganic filler, provided that no more than 95 mole percent and not less than 1 mole percent of repeat units in said copolymer are derived from said α-methylene lact(one)(am) monomer,

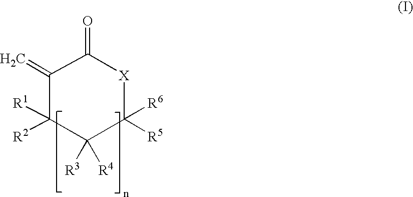

wherein:

n is 0, 1 or 2;

X is —O— or —NR⁹—; and

R¹, R², R⁵, and R⁶ each of R³ and each of R⁴, are independently hydrogen, a functional group, hydrocarbyl or substituted hydrocarbyl, and

R⁹ is independently hydrogen, or hydrocarbyl or substituted hydrocarbyl.

This invention also concerns, a composition, comprising an α-methylene lact(one)(am) homopolymer, and between 5% and 80% by weight of a filler, based on a total weight of said homopolymer, and said filler.

This invention also concerns a composition comprising an α-methylene lact(one)(am) copolymer and between 5% and 80% by weight of a filler, based on a total weight of said copolymer and said filler.

This invention also concerns a composition comprising an α-methylene lact(one)(am) homopolymer, and at least 10% by weight of alumina trihydrate based on a total weight of said homopolymer and said alumina trihydrate.

This invention also concerns a composition comprising an α-methylene lact(one)(am) copolymer and at least 10% by weight of alumina trihydrate based on a total weight of said copolymer, and said alumina trihydrate.

This invention also concerns a composition comprising at least one α-methylene lact(one)(am), a free radically copolymerizable monomer and an inorganic filler. This composition can optionally include a free radical initiator.

This invention also describes a process for manufacturing a plastic article, comprising contacting,

(a) one or more acrylate or methacrylate esters

(b) one or more a-methylene lact(one)(am) monomer of the formula (I)

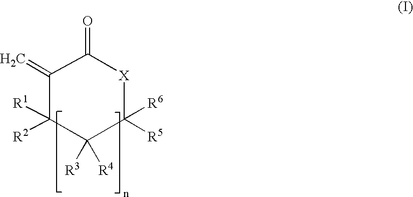

wherein:

n is 0, 1 or 2;

X is —O— or —NR⁹—; and

R¹, R², R⁵, R⁶, each of R³ and each of R⁴, are independently hydrogen, a functional group, hydrocarbyl or substituted hydrocarbyl, and

R⁹ is a hydrocarbyl or a substituted hydrocarbyl,

(c) at least one free radical initiator,

(d) at least 10 weight percent of a filler based on total weight of the said homopolymer or copolymer and the filler,

(e) optionally, one or more homopolymers or copolymers of acrylate and/or methacrylate esters,

provided that said contacting is at a sufficient temperature to cause said free radical initiator to generate free radicals; and (b) is at least 1 mole percent of the total of (a) and (b).

This invention also describes a process for manufacturing a plastic article, comprising contacting,

(a) one or more acrylate or methacrylate esters

(b) one or more a-methylene lact(one)(am) monomer of the formula (I)

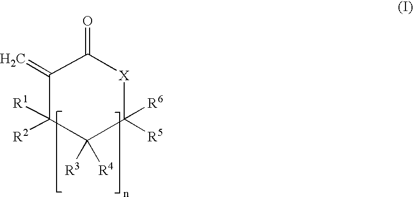

wherein:

n is 0, 1 or 2;

X is —O— or —NR⁹—; and

R¹, R², R⁵, R⁶, each of R³ and each of R⁴, are independently hydrogen, a functional group, hydrocarbyl or substituted hydrocarbyl, and

R⁹ is a hydrocarbyl or a substituted hydrocarbyl,

(c) at least one free radical initiator,

(d) at least 10 weight percent of alumina trihydrate based on total weight of the said homopolymer or copolymer and alumina trihydrate,

(e) optionally, one or more homopolymers or copolymers of acrylate and/or methacrylate esters, provided that said contacting is at a sufficient temperature to cause said free radical initiator to generate free radicals; and (b) is at least 1 mole percent of the total composition of (a) and (b).

### DETAILED DESCRIPTION OF THE INVENTION

The following terms as used herein are defined below:

By “hydrocarbyl group” is meant a univalent group containing only carbon and hydrogen. If not otherwise stated, it is preferred that hydrocarbyl groups (and alkyl groups) herein contain about 1 to about 30 carbon atoms.

By “substituted hydrocarbyl” is meant a hydrocarbyl group which contains one or more substituent groups which are inert under process conditions to which the compound containing the group is subjected. The substituent groups also do not substantially interfere with the process. If not otherwise stated, it is preferred that substituted hydrocarbyl groups herein contain 1 to about 30 carbon atoms. Included in the meaning of “substituted” are heteroatomic rings. In substituted hydrocarbyl all of the hydrogens may be substituted, as in trifluoromethyl.

By “functional group” is meant a group other than hydrocarbyl or substituted hydrocarbyl which is inert under the process conditions to which the compound or polymer containing the group is subjected. The functional groups also do not substantially interfere with any process described herein that the compound or polymer in which they are present may take part in. Examples of functional groups include halo (fluoro, chloro, bromo, and iodo), and ether groups such as —OR²² wherein R²² is hydrocarbyl or substituted hydrocarbyl.

By “copolymerizable under free radical conditions” is meant that the monomers involved are known to copolymerize under free radical polymerization conditions. Preferably, the monomers involved are vinyl monomers. The free radicals may be generated by any of the usual processes, for example thermally from radical initiators such as peroxides or azonitriles, by UV radiation using appropriate sensitizers etc., and by ionizing radiation. The copolymerization may be done in any number of known ways, for example bulk and solution polymerization. These polymers may be prepared by various types of processes, such as continuous, batch and semibatch, which are well known in the art. Many combinations of free radically copolymerizable monomers are known, see for instance J. Brandrup, et al., Ed., Polymer Handbook, 4^{th} Ed., John Wiley & Sons, New York, 1999, p. II/181-II/308.

By “copolymer of α-methylene lact(one)(am)” is meant that at least 1 mol % of the repeat unit in the copolymer are derived from the homopolymer of an α-methylene lact(one)(am) of the general formula

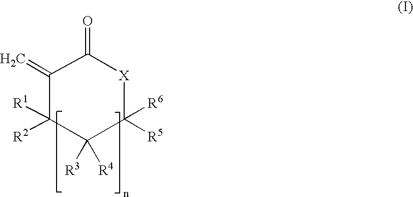

wherein X and R¹ through R⁶ and R⁹ are as defined above. In a preferred structure of I and corresponding polymeric repeat units:

n is 0; and/or

R¹, R², R³, R⁴, R⁵ and R⁶ are hydrogen or alkyl containing 1 to 6 carbon atoms, more preferably all are hydrogen; and/or

X is —O— or —NR⁹— wherein R⁹ is hydrogen or alkyl containing 1 to 6 carbon atoms, more preferably X is —O—.

By “inorganic filler” is meant a finely divided inorganic material which may cause property changes to the final article into which it is incorporated. Examples of inorganic fillers are calcium carbonate, calcium sulfate, calcium silicate, silica, clay, calcined alumina, alumina trihydrate, glass fibers, carbon fibers, titanium dioxide, spheres, talc, kaolin, feldspar, baryte, mica, hollow glass spheres, ceramic materials, and carbon black.

Decorative solid surface materials may be manufactured using a PMMA matrix and an inorganic filler, with appropriate coupling agents, initiators, etc. However, several properties of the decorative surface materials and sheets can be improved to better serve their application purpose. Herein, the properties of the composition with higher toughness and hardness improve scratch and impact resistance. A higher temperature resistance can expand the utility of the articles, for example, kitchen countertop applications would benefit from improved temperature resistance. Localized heating of the surface in table and kitchen tops can be very high when a hot object in placed on it. A polymer having a higher glass transition temperature (Tg) in this situation can help reduce damage to the surface.

The properties of the composition are improved herein by improving the matrix polymer. Described is a product and process for fabrication from a composition to give the matrix material which is a copolymer of α-methylene lact(one)(am) and an inert filler.

The α-methylene lact(one)(am) repeat unit(s) in the copolymer composition is(are) derived from the monomer

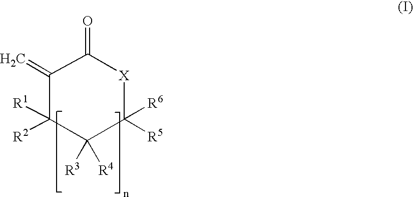

wherein X and R¹ through R⁶ are as defined above. In a preferred structure:

n is 0; and/or

R¹, R², R³, R⁴, R⁵ and R⁶ are hydrogen or alkyl containing 1 to 6 carbon atoms, more preferably all are hydrogen; and/or

X is —O— or —NR⁹— wherein R⁹ is hydrogen or alkyl containing 1 to 6 carbon atoms, more preferably X is —O—.

In a particularly preferred structure, n is 0, X is —O— and R¹, R², R⁵ and R⁶ are hydrogen, or n is 0, X is —O—, R⁶ is methyl, and R¹, R² and R⁵ are hydrogen. This structure is also known as α-methylene-γ-butyrolactone. For other preferred structures, see U.S. Pat. No. 5,880,235, which is hereby included by reference, at column 4, line 44 to column 8, line 59.

The free radically copolymerizable monomer in the composition of the copolymer may have the formula

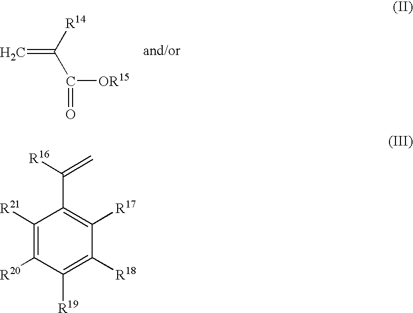

wherein R¹⁴ is hydrogen or methyl, and R¹⁵ is hydrocarbyl or substituted hydrocarbyl, preferably alkyl, R¹⁶ is hydrogen or methyl and R¹⁷, R¹⁸, R¹⁹, R²⁰ and R²¹ are each independently hydrogen, hydrocarbyl substituted hydrocarbyl or a functional group. In a preferred (II), R¹⁴ and R¹⁵ are both methyl (methyl methacrylate), and in a preferred (III), R¹⁶, R¹⁷, R¹⁸, R¹⁹, R²⁰ and R²¹ are all hydrogen (styrene). In another preferred copolymer, these repeat units are derived from methyl methacrylate and an alkyl acrylate, preferably ethyl acrylate. The free radically copolymerizable monomer may also include acrylonitrile, acrylic acid or or methacrylic acid.

Fillers of the invention can include, but are not limited to, one or more of the following:

| | | | |
|---|---|---|---|
| Aluminum | Hydroxide | Barium | Hydroxide |
| | Oxide | | Oxide |
| | Sulfate | | Sulfate |
| | Phosphate | | Phosphate |
| | Silicate | | Silicate |
| Calcium | Sulfate | Magnesium | Sulfate |
| | Silicate | | Silicate |
| | Phosphate | | Phosphate |
| | Carbonate | | Hydroxide |
| | Hydroxide | | |
| | Oxide | | |
| | Apatite | | |
| Glass | Bubbles | Clays | Kaolin |
| | Microspheres | | |

Montmorillonite

| | | |
|---|---|---|
| | Fibers | |
| Bentonite | | |
| | Beads | Pyrophyllite |
| | Flakes | |
| | Powder | |
| Additional: | | |
| | Mica | Cristobalite |
| | Powder Talc | Wood flour |
| | Gypsum | Feldspar |
| | Titanium Dioxide | Carbon black |
| | Quartz | Zircon |
| | Diatomaceous earth | Borax |
| | Silica | Wollastonite |
| | Calcite | |
| | Carbon fiber | |
| | Ceramic Microspheres | Calcined alumina |
| | Baryte | |

In a preferred composition, an inorganic filler may be a mixture of alumina trihydrate with any of the other inorganic fillers listed here. In a particularly preferred composition, inorganic filler is alumina trihydrate. The filler can also be an organic filler which includes, but is not limited to nylon fiber, polyester fiber.

A preferred content of the filler is about 5% to about 80% by weight of the total article. In a more preferred combination, the filler content is in the range of about 40% to about 60% by weight. A preferred content of the polymer in the final article is about 40% to about 60%, by total weight of the polymer and alumina trihydrate.

A preferred content of alumina trihydrate filler is about 10% to about 80% by weight of the total article. In a more preferred combination, the alumina trihydrate content is in the range of about 40% to about 60% by weight. A preferred content of the polymer in the final article is about 40% to about 60%, by total weight of the polymer and alumina trihydrate.

The α-methylene lact(one)(am) repeating unit weight content in the total polymer present in the composition is preferred in the range of about 1% to about 95%, preferably about 30% to about 40% of the total polymer weight, with a preferable minimum amount of about 2% or a more preferable minimum amount of about 5% or a more preferable amount of about 10% or a further preferable amount of about 20% and preferable maximum amount of about 80% or a more preferable maximum amount of about 65% and a further preferable maximum amount of about 50% and a more preferable amount of about 40%, such that any preferable minimum amount can be combined with any preferable maximum amount.

The content of the repeat units derived from the free radically copolymerizable monomer(s) is preferred from about 5% to about 99%; more preferably about 60% to about 70% of the copolymer. In a preferred composition, the free radically copolymerizable monomer is methyl methacrylate. In another preferred composition, the free radically copolymerizable monomers are methyl methacrylate and an alkyl acrylate, wherein the alkyl group has 1-8 carbon atoms, more preferably ethyl acrylate or n-butyl acrylate, and/or the alkyl acrylate content is not more than about 10 mole % of the radically copolymerizable comonomer content. It is also possible to use glycidyl acrylate or methacrylate in any of the above compositions. In a particularly preferred composition, the free radically copolymerizable monomer may be a mixture of methyl methacrylate and ethyl or butyl acrylate, where the ethyl or butyl acrylate content is not more than about 5 weight % of the radically copolymerizable comonomer content in the final copolymer matrix. Such copolymers are described in U.S. Pat. No. 5,880,235, which is hereby incorporated by reference.

When an α-methylene lact(one)(am) is present in a copolymer, it tends to raise the glass transition temperature (T_{g}). For example, in a copolymer with methyl methacrylate, the T_{g} will normally be above the T_{g} of a PMMA homopolymer.

A preferred composition useful for a decorative sheet is a copolymer of at least one of α-methylene lact(one)(am) monomer and at least one of the alkyl acrylate monomer with at least 30 weight % inorganic filler, from one or more of the inorganic fillers listed previously. A particularly preferred composition is a copolymer matrix of α-methylene-γ-butyrolactone, and methyl methacrylate or a copolymer of α-methylene-γ-butyrolactone and ethyl acrylate, with at least 10 weight percent of alumina trihydrate filler.

Another type of monomer that may be used is a monomer that contains more than one polymerization sites for e.g., a di- or tri-acrylate, or methacrylate, or vinyl styrene. During the polymerization, these monomers cause crosslinking of the polymer. Usually, relatively small amounts are added so that the monomer is not highly crosslinked. Included in the composition herein are those compositions where PMMA or another homo- or copolymer is present in the composition which are a mixture of PMMA or a copolymer of PMMA and alkyl acrylate.

Decorative sheet compositions described herein usually have better thermal resistance compared to a composition made with a pure PMMA, see for instance Table 1 in Example 3, where the glass transition temperatures of α-MBL polymer, of PMMA and of copolymers of α-MBL and MMA are given.

Another advantage that copolymerization of α-methylene lactone often imparts to the decorative sheet manufacture process is the high rate of chemical reaction (also known as cure rate). Table 1 also lists the time in minutes taken to achieve the highest temperature of reaction, by polymeric matrices with varying α-methylene lactone contents.

Table 3 in Example 3 gives experimentally determined modulus of elasticity properties. An improvement in modulus of elasticity is found with an increasing α-methylene lactone content.

Filled polymer compositions described herein have a better refractive index match between the polymer and the filler due to the higher refractive index of poly(MBL) compared to PMMA. This can result in materials with a greater translucency.

All of the compositions herein may additionally comprise other materials commonly found in thermoplastic compositions, such as, dyes, pigments, UV stabilizers, processing aids, flame retardants, antioxidants, and antiozonants. These materials may be present in conventional amounts, which vary according to the type(s) of material(s) being added and their purpose in being added.

It was found that incorporating the compositions of this invention into a solid surface material caused the solid surface material to exhibit antimicrobial/antibacterial properties. The antimicrobial/antibacterial effectiveness was tested with Escherichia Coli bacteria in a residual self-sanitizing test. Example 8 demonstrates that α-MBL-based decorative sheet reduced the bioburden by 3.92 logs, or greater than 99.9% reduction of bacteria as compared to the control sheet. For purposes of antimicrobial/antibacterial activity, the compositions of this invention can be incorporated into a wide array of products, such as, bathroom vanity tops, sinks, shower stalls, kitchen counter tops, solid surfaces in hospitals, nursing homes and daycare facilities, commercial and residential food preparation facilities, office supplies, and other applications where it is desirable to minimize human contact with bacteria.

### EXAMPLES

In the Examples the following abbreviations are used:

VAZO® 67—azobis(methylbutyronitrile)

DMSO—dimethyl sulfoxide

MMA—methyl methacrylate

α-MBL—α-methylene-γ-butyrolactone

T_{g}—glass transition temperature

DMA—dynamic mechanical analysis

ATH—alumina trihydrate

GDMA—Glycol dimercaptoacetate

PMMA—Poly(methyl methacrylate)

TSA®—Trypticase® Soy Agar

TSB®—Trypticase® Soy Broth

MMA was obtained from Aldrich Chemical Company, Inc., Milwaukee, Wis., U.S.A. AIBN, Zonyl® UR fluorosurfactant external release coating were obtained from E. I. du Pont de Nemours & Co., Wilmington, Del., U.S.A. Silastic® gasket (silicone rubber) was obtained from Dow Corning Corp., Midland, Mich., U.S.A. t-butyl peroxyneodecanoate was obtained at a 25 wt % dispersion in mineral oil (Lupersol® 10M75) from Atofina, King of Prussia, Pa. The Trypticase®soy broth and agar were obtained from Becton, Dickinson Biosciences of Franklin Lakes, N.J.

Haze and transmission were measured according to ASTM D1003. The flexural modulus was measured by ASTM D790. DMA measurements were performed by ASTM 5023 with torque force of 1.2-1.4 N·m. The bar was scanned in 5 frequencies (0.3, 1, 3, 10 and 30 Hz) at 1° C./min rate from −140° C. to 180° C. The oscillation amplitude was 10 μm. Glass transition temperatures (T_{g}) were measured by ASTM D3418 at a heating rate of 10° C./min and the T_{g} was measured as the midpoint of the transition.

### EXPERIMENT 1

### Preparation of Filled Sheet (Thermal Cure)

The following ingredients are added to a 1000 mL reaction kettle, fitted with a temperature probe, air-driven stirrer, rubber septum and a reflux condenser:

| | |
|---|---|
| trimethylolpropane trimethacrylate | 4.48 g |
| 10% solution of poly(methyl methacrylate-co-ethyl | 492.84 g |
| acrylate 96/4) in MMA | |
| Pigment paste | 0.53 g |
| t-butyl peroxyneodecanoate, 25% dispersion in mineral oil | 1.79 g |
| VAZO 67 | 0.36 g |

After mixing these ingredients, 500 g of ATH were added portionwise over a two minute interval. During the portionwise addition of the ATH, the stirring speed was increased to about 1500 rpm.

After the ATH addition was complete, the stirring speed was increased to 2000 rpm and maintained for 10 min. About 2.5 g of MMA monomer was added and the mix was then evacuated at 100 Pa for two min. with 1000 rpm stirring. The mixture was poured into a casting mold constructed from two stainless metal plates (25.4 cm×25.4 cm×1.0 mm) separated by a Silastic® gasket (12.95 mm thickness). Each of the metal plates was coated with a Zonyl® UR external release coating. The casting mold was assembled using spring clamps. After bleeding a small amount of air from the cell, the sealed cell was submerged vertically in an 80° C. waterbath. Twenty min. later, the casting cell was removed from the waterbath and placed in a 120° C. circulating hot air oven for 60 min.

### Example 1-3

### Preparation of Filled Sheet Containing α-methylene g-butyrolactone (Thermal Cure)

Three polymer syrups of 10 weight % solution of poly(methyl methacrylate-co-ethyl acrylate) (96/4 weight percent) in a MBL/MMA mixtures were made by slowly dissolving the polymer in the monomer in a reaction kettle. In the 100% MBL mixture, no acrylic odor was observed, nor was there any foaming or bubbling in the degassing step. These syrups were used to make filled acrylic sheet as described in Experiment 1. The color of these sheets was similar to the sheet of Experiment 1.

TABLE 1
Time in minutes taken to achieve the highest temperature
of reaction and T_{g} of MBL/MMA filled sheet (thermal cure)

| | | Time to peak | |
|---|---|---|---|
| | MBL/MMA | temperature | |
| Example | (Wt %) | (min) | T_{g} (° C.) |
| 1 | 100/0 | 4.5 min | 177 |
| 2 | 50/50 | 4.5 min | 148 |
| 3 | 27/75 | 9.5 min | 122 |

TABLE 2
Properties of MBL/MMA filled sheet (thermal cure)

| | | | | MBL |
|---|---|---|---|---|
| | | | MMA | filled sheet |
| Property | | ASTM | filled sheet | Example 1 |
| Ultimate stress | MPa | ASTM D790 | 58.2 | 51.3 |
| Ultimate strain | % | ASTM D790 | 2.26 | 0.503 |
| Energy to break | N.m | ASTM D790 | 0.411 | 0.061 |
| Elastic modulus | GPa | ASTM D790 | 6.46 | 10.70 |

TABLE 3
DMA data on MBL/MMA filled sheets (thermal cure)

| Thermal Properties | Example 1 | Example 2 | Example 3 | 100% PMMA cured |
|---|---|---|---|---|
| Modulus E′ @ 25° C. | 10.4 GPa | 8.2 GPa | 7.9 GPa | 7.4 GPa |
| Tα @ 1 Hz by | 122.0° C. | 77° C., 105° C. | 93° C. | 107° C. |
| DMA E″ peak | | | | |
| Tβ @ 1 Hz by | 61.1° C., E_{act} = | 2.0° C., E_{act} = | 12.0° C., E_{act} = | 16.8° C., E_{act} = |
| DMA E″ peak | 96 kcal/mole | 20.9 kcal/mole | 19 kcal/mole | 18 kcal/mole |
| Tβ′ @ 1 Hz by | 2.6° C., E_{act} = | | | |
| DMA E″ peak | 26 kcal/mole | | | |
| Tγ @ 1 Hz by | | −100° C., E_{act} = | −102° C., E_{act} = | −105° C., E_{act} = |
| DMA E″ peak | | 13 kcal/mole | 14 kcal/mole | 13 kcal/mol |

Tα is the highest relaxation temperature corresponding to the glass transition, Tβ and Tβ′ are the next lowest relaxation temperatures believed to be from the lactone ring motion, Tγ is the lowest observed relaxation temperature believed to be the motion of —CH₃.

### Example 4

### Preparation of Filled Sheet Containing Methylene Butyrolactone (Chemical Cure, MBL 10 Weight % of Available Monomer)

The following ingredients were sequentially added to a 2000 mL reaction kettle, fitted with a temperature probe, air-driven stirrer, rubber septum and a reflux condenser:

| | |
|---|---|
| t-Butyl peroxymaleic acid | 9.81 g |
| Pearl grey pigment paste | 0.91 g |
| Dioctyl sodium sulfosuccinate | 3.92 g |
| Trimethylolpropane trimethacrylate | 6.54 g |
| MMA | 56.22 g |
| α-MBL | 52.96 g |
| 24% solution of poly(methyl methacrylate) in MMA | 544.6 g |

After mixing these ingredients for 1 min at room temperature, 1020 g of ATH were added portionwise over a 2 min interval and then stirred for 10 min.

About 5.0 g of MMA was added. The mix was then evacuated at 10 KPa with stirring. Vacuum was lowered to 20 KPa with stirring, then gently warmed to 40° C. using a waterbath. The following ingredients were sequentially injected in rapid succession:

| | |
|---|---|
| Demineralized water | 2.04 g |
| Calcium hydroxide dispersion in butylmethacrylate monomer | 2.81 g |
| Glycol dimercaptoacetate (GDMA) | 1.43 g |

The addition of the GDMA was considered the starting point in time of experiment. The slurry was mixed at 41° C. for 10 s. Mixing was discontinued and the vacuum released and poured into a 12.6 mm tilted adiabatic casting mold.

### Example 5

### Preparation of Filled Sheet Containing Methylene Butyrolactone (Chemical Cure, MBL 20% of Available Monomer)

The recipe of Example 4 was repeated with the following changes only:

| | |
|---|---|
| MMA | 3.26 g |
| MBL | 105.92 g |

### Example 6

### Preparation of Filled Sheet Containing Methylene Butyrolactone (Chemical Cure, MBL 5% of Available Monomer)

The recipe of Example 4 was repeated with the following changes only:

| | |
|---|---|
| MMA | 82.70 g |
| MBL | 26.48 g |

### Example 7

### Preparation of Filled Sheet Containing Methylene Butyrolactone (Chemical Cure, MBL 15% of Available Monomer)

The recipe of Example 4 was repeated with the following changes only:

| | |
|---|---|
| MMA | 29.74 g |
| MBL | 79.44 g |

TABLE 4
Time in minutes taken to achieve the highest temperature
of reaction and T_{g} of MBL/MMA filled sheet, chemical cure.

| | | | Time to achieve |
|---|---|---|---|
| | | Peak | Peak |
| | | Temperature | Temperature (+/− |
| Example | MBL/MMA Wt % | ° C. (+/−2° C.) | 0.5 min) |
| 6 | 5/95 | 129 | 13 min |
| 4 | 10/90 | 131 | 10.5 min |
| 7 | 15/85 | 133 | 7 min |
| 5 | 20/80 | 133 | 6 min |

TABLE 5
Properties of MBL/MMA filled sheet, chemical cure (ASTM D790)

| Property | | PMMA sheet | Ex 4 | Ex 6 | Ex 7 |
|---|---|---|---|---|---|
| Ultimate stress | MPa | 79.8 | 67.7 | 67.6 | 66.8 |
| Ultimate strain | % | 1.06 | 0.88 | 0.90 | 0.83 |
| Energy to break | J | 0.441 | 0.315 | 0.311 | 0.284 |
| Elastic modulus | GPa | 9.46 | 9.57 | 8.99 | 9.57 |

### Example 8

### Antimicrobial Activity of α-MBL Filled Sheet

MBL filled acrylic sheet from Example 1 was cut in 5×5 cm tiles. Corian® control pieces were 6×6 cm. The test organism was Escherichia coli, ATCC #25922. The inoculum was prepared by diluting an overnight culture (grown in Trypticase® Soy broth) 1:1,000 (v/v) in dilute phosphate buffer. All polished surfaces of the tiles were wiped with isopropyl alcohol and cheesecloth to clean the surface. A 0.5 mL aliquot of the inoculum was pipetted and spread over the surface of each Corian® tile and a 0.42 mL aliquot was spread over the surface of each MBL tile. The inoculated tiles were each placed in a closed, sterile glass petri plate and placed in open fiberglass trays. The samples were incubated at 25° C. and 85% RH. At the end of the incubation time, the tiles were washed twice with enough sterile phosphate buffer to bring the combined inoculum and wash buffer to 10 mL. The tiles were then wiped dry with a piece of sterile gauze to ensure that the inoculum was wiped completely from the tile. The viable bacteria were then enumerated using a standard serial-dilution spread-plating technique on Trypticase® soy agar (TSA). The lower limit of detection with this method is 1.0×10² CFU/mL (Colony Forming Units per milliliter). The maintenance of antimicrobial activity of the tiles is expressed as the t value where,

t=log CFU/mL of control tile−log CFU/mL of test tile (both at the same exposure time)

The MBL tiles demonstrated significant antibacterial activity in 5 h of exposure to E. coli and reduced the bioburden by 3.92 logs (>99.9% reduction) compared to the Corian® control.

What is claimed is:

1. A composition comprising,
(a) an α-methylene lact(one)(am) copolymer comprising,
(i) at least one α-methylene lact(one)(am) monomer of Formula I, and
(ii) at least one other free radically copolymerizable monomer, and
(b) a filler,
provided that no more than 95 mole percent and not less than 1 mole percent of repeat units in said α-methylene lact(one)(am) copolymer are derived from said α-methylene lact(one)(am) monomer, 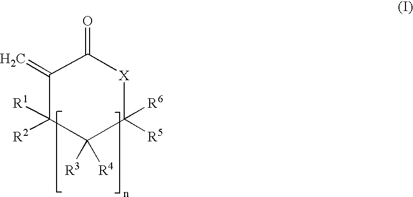
wherein:
n is 0, 1 or 2;
X is —O— or —NR⁹—; and
R¹, R², R⁵, R⁶, each of R³ and each of R⁴, are independently hydrogen, a functional group, hydrocarbyl or substituted hydrocarbyl, and
R⁹ is a hydrocarbyl or a substituted hydrocarbyl.

2. A composition comprising an α-methylene lact(one)(am) homopolymer, and from 5% to 80% by weight of a filler, based on the total weight of said homopolymer and said filler.

3. A composition comprising the α-methylene lact(one)(am) copolymer of claim 1 and from 5% to 80% by weight of a filler, based on the total weight of said copolymer and said filler.

4. A composition comprising an α-methylene lact(one)(am) homopolymer and at least 10% by weight of alumina trihydrate based on the total weight of said homopolymer and said alumina trihydrate.

5. A composition comprising the α-methylene lact(one)(am) copolymer of claim 1 and at least 10% by weight of alumina trihydrate based on the total weight of said copolymer and said alumina trihydrate.

6. The composition as recited in claim 1 wherein R¹, R², R³, R⁴, R⁵ and R⁶ are all independently hydrogen or alkyl containing 1 to 6 carbon atoms, and X is oxygen.

7. The composition as recited in claim 1 wherein n is 0.

8. The composition as recited in claim 1 wherein the free radically copolymerizable monomer comprises at least one of acrylonitrile, methalacrylic acid, compounds of Formula II and compounds of Formula III, 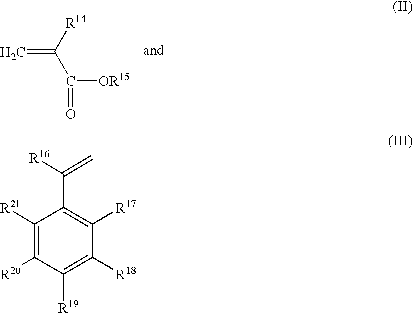
wherein R¹⁴ is hydrogen or methyl, R¹⁵ is hydrocarbyl or substituted hydrocarbyl, and R¹⁶ is hydrogen or methyl, and R¹⁷, R¹⁸, R¹⁹, R²⁰ and R²¹ are each independently hydrogen, hydrocarbyl substituted hydrocarbyl or a functional group.

9. The composition as recited in claim 3 wherein the free radically copolymerizable monomer of claim 1 is the compound of Formula II, 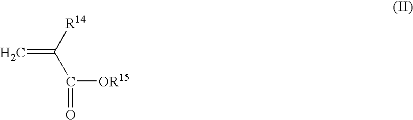
wherein R¹⁴ is hydrogen or methyl, and R¹⁵ is hydrocarbyl or substituted hydrocarbyl.

10. The composition as recited in claim 5 wherein the free radically copolymerizable monomer is the compound of Formula II, 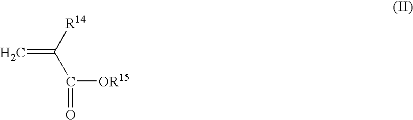
wherein R¹⁴ is hydrogen or methyl, and R¹⁵ is hydrocarbyl or substituted hydrocarbyl.

11. A composition comprising, at least one α-methylene lact(one)(am), a free radically copolymerizable monomer, an inorganic filler, and optionally a free radical initiator.

12. The composition of claim 1 wherein the copolymer is crosslinked.

13. The composition of claim 2 wherein the homopolymer is crosslinked.

14. The composition of claim 3 wherein the copolymer is crosslinked.

15. The composition of claim 4 wherein the homopolymer is crosslinked.

16. The composition of claim 5 wherein the copolymer is crosslinked.

17. The composition of claim 11 wherein or the copolymer is crosslinked.

18. The composition of claim 1 in the form of a sheet or a molded article.

19. The composition of claim 2 in the form of a sheet or a molded article.

20. The composition of claim 3 in the form of a sheet or a molded article.

21. The composition of claim 4 in the form of a sheet or a molded article.

22. The composition of claim 5 in the form of a sheet or a molded article.

23. The composition of claim 11 in the form of a sheet or a molded article.

24. The composition of claim 1 in the form of a solid surface material used as a decorative surface.

25. The composition of claim 2 in the form of a solid surface material used as a decorative surface.

26. The composition of claim 3 in the form of a solid surface material used as a decorative surface.

27. The composition of claim 4 in the form of a solid surface material used as a decorative surface.

28. The composition of claim 5 in the form of a solid surface material used as a decorative surface.

29. The composition of claim 11 in the form of a solid surface material used as a decorative surface.

30. The composition of claim 1 in the form of a kitchen top, counter top, table top, bathroom counter top, a wall covering, a kitchen sink, a bathroom sink, or a bathtub.

31. The composition of claim 2 in the form of a kitchen top, counter top, table top, bathroom counter top, a wall covering, a kitchen sink, a bathroom sink, or a bathtub.

32. The composition of claim 3 in the form of a kitchen top, counter top, table top, bathroom counter top, a wall covering, a kitchen sink, a bathroom sink, or a bathtub.

33. The composition of claim 4 in the form of a kitchen top, counter top, table top, bathroom counter top, a wall covering, a kitchen sink, a bathroom sink, or a bathtub.

34. The composition of claim 5 in the form of a kitchen top, counter top, table top, bathroom counter top, a wall covering, a kitchen sink, a bathroom sink, or a bathtub.

35. The composition of claim 11 in the form of a kitchen top, counter top, table top, bathroom counter top, a wall covering, a kitchen sink, a bathroom sink, or a bathtub.

36. A solid surface material exhibiting antimicrobial effectiveness, the solid surface material comprising the composition of claim 1.

37. A solid surface material exhibiting antimicrobial effectiveness, the solid surface material comprising the composition of claim 2.

38. A solid surface material exhibiting antimicrobial effectiveness, the solid surface material comprising the composition of claim 3.

39. A solid surface material exhibiting antimicrobial effectiveness, the solid surface material comprising the composition of claim 4.

40. A solid surface material exhibiting antimicrobial effectiveness, the solid surface material comprising the composition of claim 5.

41. A solid surface material exhibiting antimicrobial effectiveness, the solid surface material comprising the composition of claim 11.

42. A process for manufacturing a plastic article, comprising the step of contacting
(a) one or more acrylate or methacrylate esters,
(b) one or more α-methylene lact(one)(am) monomers of Formula I, 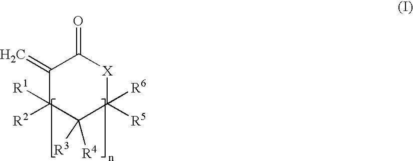
wherein:
n is 0, 1 or 2;
X is —O— or —NR⁹—; and
R¹, R², R⁵, R⁶, each of R³ and each of R⁴, are independently hydrogen, a functional group, hydrocarbyl or substituted hydrocarbyl, and
R⁹ is a hydrocarbyl or a substituted hydrocarbyl
(c) one or more free radical initiators,
(d) at least 10 weight percent of a filler based on total weight of the said homopolymer or copolymer and the filler,
(e) optionally one or more homopolymers or copolymers of acrylate and/or methacrylate esters,
said contacting being at a temperature sufficient to cause said free radical initiator to generate free radicals; and wherein the α-methylene lact(one)(am) monomer of Formula I is at least 1 mole percent of the total composition of (a) and (b).

43. A process for manufacturing a plastic article, comprising the step of contacting
(a) one or more acrylate or methacrylate esters,
(b) one or more α-methylene lact(one)(am) monomers of Formula I, 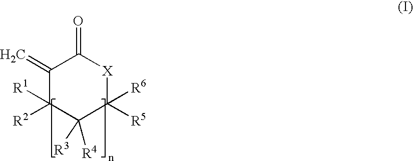
wherein:
n is 0, 1 or 2;
X is —O— or —NR⁹—; and
R¹, R², R⁵, R⁶, each of R³ and each of R⁴, are independently hydrogen, a functional group, hydrocarbyl or substituted hydrocarbyl, and R⁹ is a hydrocarbyl or a substituted hydrocarbyl
(c) at least one free radical initiator
(d) at least 10 weight percent of alumina trihydrate based on total weight of the said homopolymer or copolymer and alumina trihydrate,
(e) optionally one or more homopolymers or copolymers of acrylate and/or methacrylate esters,
said contacting being at a temperature sufficient to cause said free radical initiator to generate free radicals; and wherein the α-methylene lact(one)(am) monomers of Formula I is at least 1 mole percent of the total composition of (a) and (b).

44. The process of claim 42, further comprising using the plastic article as a decorative surface.

45. The process of claim 43, further comprising using the plastic article as a decorative surface.
